(19) United States
(12) Patent Application Publication
(10) Pub. No.: US 2025/0343452 A1
(43) Pub. Date: Nov. 6, 2025

(54) MOTOR ROTOR WITH CYLINDRICAL MAGNET

(71) Applicant: IHI Corporation, Koto-ku (JP)

(72) Inventor: Hikaru SUGIURA, Tokyo (JP)

(21) Appl. No.: 19/269,042

(22) Filed: Jul. 15, 2025

Related U.S. Application Data
(63) Continuation of application No. PCT/JP2024/001917, filed on Jan. 23, 2024.

(30) Foreign Application Priority Data
May 24, 2023 (JP) 2023-085757

(51) Int. Cl. H02K 1/2733; B22F 3/10; H02K 1/02; H02K 7/14; H02K 15/035

(52) U.S. Cl. CPC H02K 1/2733; B22F 3/10; H02K 1/02; H02K 7/14; H02K 15/035; B22F 2301/45

(57) ABSTRACT

A motor rotor includes a cylindrical permanent magnet located around a rotary shaft, and a cylindrical armoring ring located around the permanent magnet. The permanent magnet and the armoring ring are integrally sintered.

### CROSS-REFERENCE TO RELATED APPLICATIONS

This application is a continuation application of PCT Application No. PCT/JP2024/001917, filed on Jan. 23, 2024, which claims the benefit of priority from Japanese Patent Application No. 2023-085757, filed on May 24, 2023. The entire contents of the above listed PCT and priority applications are incorporated herein by reference.

### BACKGROUND

### Field

The present disclosure relates to a motor rotor, an electric motor, a turbocharger, and a method for manufacturing a motor rotor.

### Description of the Related Art

Japanese Unexamined Patent Application Publication No. H9-275651 and Japanese Patent No. 4681008 discloses an electric motor. A rotor of this electric motor includes a permanent magnet attached to a shaft and an armoring ring surrounding the permanent magnet. When the rotor rotates at high speed and a strong centrifugal force acts on the permanent magnet, the armoring ring prevents the permanent magnet from coming off the rotor. The armoring ring is fitted and fixed to an outer circumference of the permanent magnet by shrink fitting.

### SUMMARY

If the armoring ring is shrink-fitted to the outer circumference of the permanent magnet, it may be necessary to polish the outer circumference of the permanent magnet and an inner circumference of the armoring ring to adjust their surface roughness, and tolerances of both components must be strictly controlled. Accordingly, if the above-mentioned method is used, it may decrease a productivity of a motor rotor, and a productivity of an electric motor and a turbocharger to which the motor rotor is applied.

### BRIEF DESCRIPTION OF THE DRAWINGS

FIG. 1 is a cross-sectional view including a rotation axis of an example turbocharger.

FIG. 2 is a cross-sectional view including a rotation axis of an example motor rotor.

FIG. 3A is a diagram illustrating a manufacturing process of an example motor rotor.

FIG. 3B is a diagram illustrating a manufacturing process of an example motor rotor.

FIG. 3C is a diagram illustrating a manufacturing process of an example motor rotor.

### DETAILED DESCRIPTION

Disclosed herein is an example motor rotor. The motor rotor includes a cylindrical magnet disposed around a rotary shaft and a cylindrical armoring ring disposed around the magnet. The magnet and the armoring ring are integrally sintered.

In some examples, the magnet and the armoring ring may be integrally sintered by sintering a composite molded body formed by superposing a metal powder molded body formed from a metal powder that is a material of the armoring ring around another metal powder molded body formed from another metal powder of a material of the magnet.

In some examples, the magnet may be a samarium cobalt magnet, and a material of the armoring ring is alloy 718.

Additionally, an example electric motor is disclosed herein. The electric motor includes some examples of the motor rotor.

Additionally, an example turbocharger is disclosed herein. The turbocharger includes some examples of the electric motor as an assisting electric motor that applies a torque to the rotary shaft of an impeller.

Additionally, an example method for manufacturing a motor rotor is described herein. The method includes a process of integrally sintering the magnet and the armoring ring by sintering a composite molded body formed by superposing a metal powder molded body formed from a metal powder that is a material of the armoring ring around another metal powder molded body formed from another metal powder of a material of the magnet.

In the following description, with reference to the drawings, the same reference numbers are assigned to the same components or to similar components having the same function, and overlapping description is omitted.

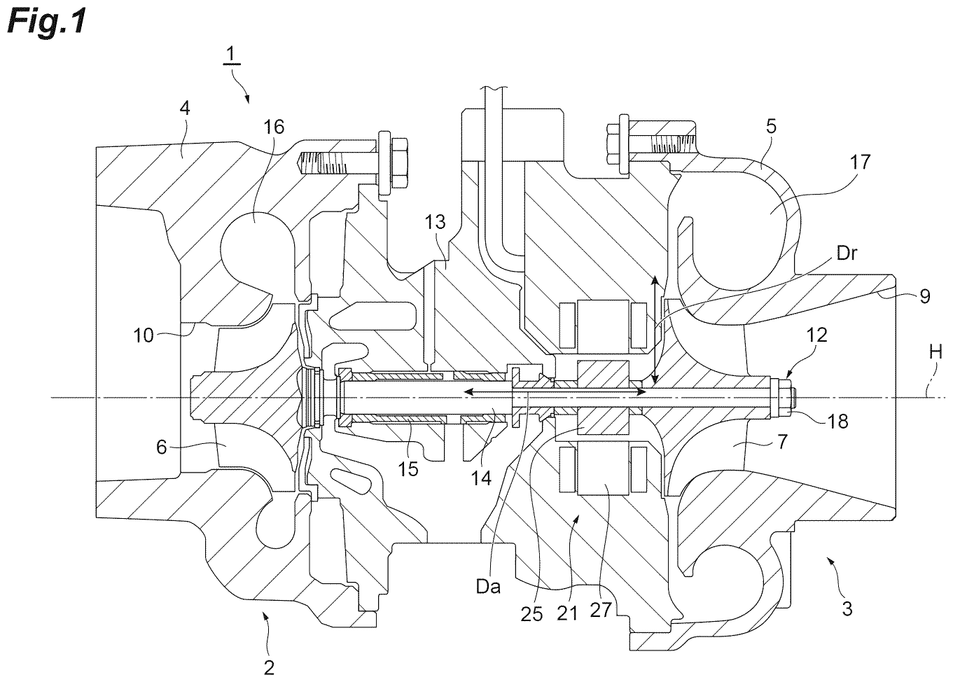

FIG. 1 is a cross-sectional view of a turbocharger 1 along a cross-section including a rotation axis H. The turbocharger 1 is a variable displacement turbocharger including an example motor rotor. In the following description, when the terms “axial direction,” “radial direction,” and “circumferential direction” are simply used, they respectively indicate an axial direction Da, a radial direction Dr, and a circumferential direction Dc of a rotary shaft 14, which will be described later.

The turbocharger 1 is applied to machines that operate by a chemical reaction between fuel and oxygen, such as internal combustion engines of vehicles and fuel cells, for example. The turbocharger 1 increases an amount of oxygen relating to the above-mentioned chemical reaction by compressing and supplying air to these machines. As shown in FIG. 1, the turbocharger 1 includes a turbine 2 and a compressor 3. The turbine 2 includes a turbine housing 4 and a turbine impeller 6 housed in the turbine housing 4. The turbine housing 4 has a scroll flow passage 16 that extends in the circumferential direction Dc around the turbine impeller 6. The compressor 3 includes a compressor housing 5 and a compressor impeller 7 housed in the compressor housing 5. The compressor housing 5 has a scroll flow passage 17 that extends in the circumferential direction Dc around the compressor impeller 7.

The turbine impeller 6 is provided at one end of the rotary shaft 14, and the compressor impeller 7 is provided at the other end of the rotary shaft 14. A bearing housing 13 is provided between the turbine housing 4 and the compressor housing 5. The rotary shaft 14 is rotatably supported by the bearing housing 13 via a bearing 15, and the rotary shaft 14, the turbine impeller 6, and the compressor impeller 7 rotate around the rotation axis H as an integrated rotating body 12.

The turbine housing 4 is provided with an exhaust gas inlet and an exhaust gas outlet 10. Exhaust gas discharged from an internal combustion engine flows into the turbine housing 4 through the exhaust gas inlet. After that, the exhaust gas flows into the turbine impeller 6 through the scroll flow passage 16, causing the turbine impeller 6 to rotate. After that, the exhaust gas flows out of the turbine housing 4 through the exhaust gas outlet 10.

The compressor housing 5 is provided with an intake port 9 and a discharge port. When the turbine impeller 6 rotates as described above, the compressor impeller 7 rotates via the rotary shaft 14. The rotating compressor impeller 7 takes in outside air through the intake port 9. This air passes through the compressor impeller 7 and the scroll flow passage 17, and is compressed and discharged from the discharge port. The compressed air discharged from the discharge port is supplied to the internal combustion engine.

Further, the turbocharger 1 is provided with an electric motor 21. When a torque of the rotary shaft 14 is insufficient, for example, when a vehicle is accelerating, the electric motor 21 applies a torque to the rotary shaft 14 to compensate for the shortage. The electric motor 21 is, for example, a brushless AC motor, and includes a motor rotor 25, which is a rotor, and a motor stator 27, which is a stator. A battery of the vehicle can be used for a driving source of the electric motor 21. In addition, when the vehicle is decelerating, the electric motor 21 may generate electric power regeneratively using rotational energy of the rotating body 12. The electric motor 21 has characteristics that allow it to handle high-speed rotation of the rotary shaft 14 (for example, 100,000 to 200,000 rpm).

The motor rotor 25 is disposed between the bearing 15 and the compressor impeller 7 in the axial direction Da. The rotary shaft 14 is inserted through a center of the motor rotor 25, and the motor rotor 25 is fastened to the rotary shaft 14 together with the compressor impeller 7 by a nut 18 (see FIG. 1). Thus, the motor rotor 25 is fixed to the rotary shaft 14 and can rotate together with the rotary shaft 14.

The motor stator 27 is housed in the bearing housing 13 and is disposed to surround the motor rotor 25 in the circumferential direction Dc. The motor stator 27 includes a plurality of coils and an iron core. When an electric current is supplied to the coils and the motor stator 27 generates a magnetic field, a circumferential force acts on a permanent magnet 37 of the motor rotor 25 due to this magnetic field, and as a result, a torque is applied to the rotary shaft 14.

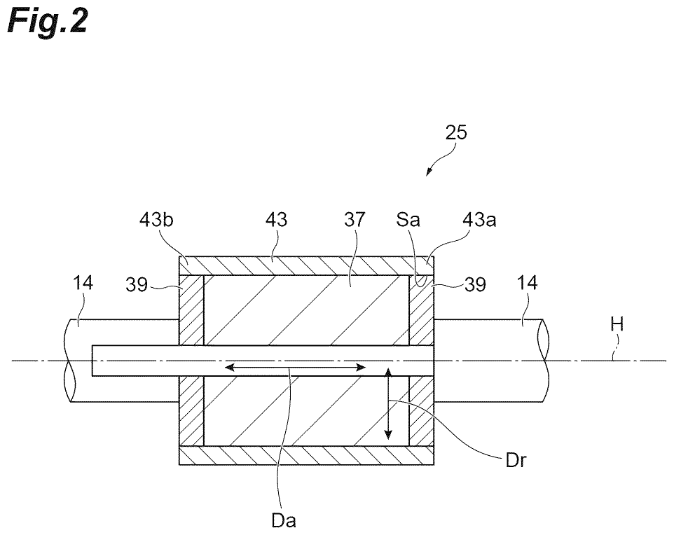

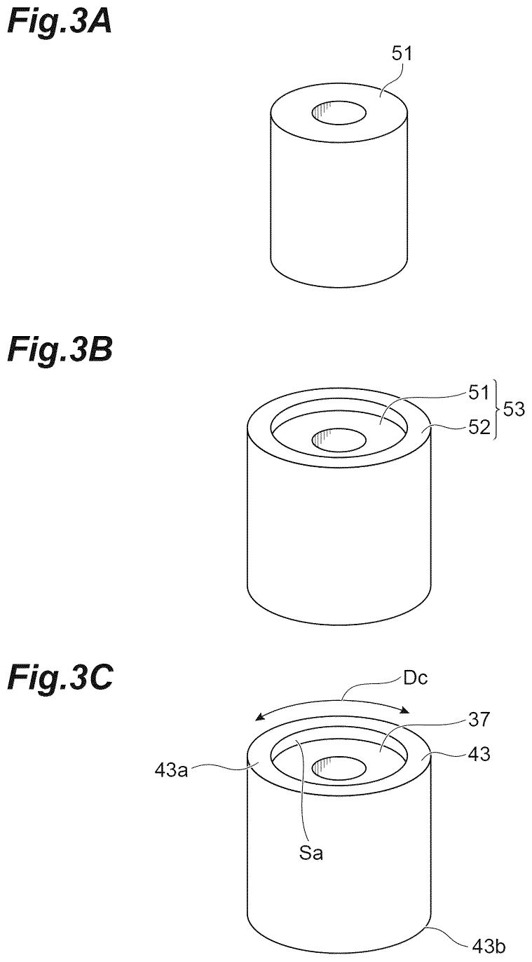

Next, the motor rotor 25 and a manufacturing method thereof will be further described with reference to FIGS. 2 and 3. As shown in FIG. 2, the motor rotor 25 is an assembly including the permanent magnet 37, end rings 39, and an armoring ring 43. The permanent magnet 37 is cylindrical and is disposed around the rotary shaft 14. The armoring ring 43 is cylindrical and is disposed around the permanent magnet 37. The armoring ring 43 includes a first cylindrical end portion 43a and a second cylindrical end portion 43b. The first cylindrical end portion 43a protrudes from the permanent magnet 37 in the axial direction Da. The second cylindrical end portion 43b protrudes from the permanent magnet 37 in the axial direction Da.

The armoring ring 43 prevents fragments of the permanent magnet 37 from scattering in the radial direction Dr if the permanent magnet 37 is broken. In addition, the armoring ring 43 may need to have a certain degree of rigidity to suppress distortion of the permanent magnet 37 and reduce the possibility of breakage to the permanent magnet 37.

A pair of ring-shaped end rings 39 have outer diameters that are approximately the same as an inner diameter of the armoring ring 43, and are disposed to sandwich the permanent magnet 37 and the armoring ring 43 in the axial direction Da. Each of the end rings 39 contacts the permanent magnet 37 in the axial direction Da.

The permanent magnet 37 is integrally joined to the armoring ring 43 in a manner described below. The end rings 39 are contacted (e.g., press-fitted) onto an inner circumferential surface Sa of the armoring ring 43 and onto the rotary shaft 14. One of the end rings 39 is press-fitted onto the inner circumferential surface Sa of the first cylindrical end portion 43a, while the other end ring 39 is press-fitted onto the inner circumferential surface Sa of the second cylindrical end portion 43b. On the basis of such a joint structure, a torque applied to the permanent magnet 37 by the electric motor 21 is transmitted from the permanent magnet 37 to the rotary shaft 14 via the armoring ring 43 and the end rings 39 in order. Also, the permanent magnet 37 is joined to the rotary shaft 14 with an adhesive, but this joint strength may be weaker than that of the joint between the end rings 39 and the rotary shaft 14. In the mode, the joint strength between the permanent magnet 37 and the rotary shaft 14 may be only enough to withstand polishing of an outer circumference of the permanent magnet 37 during manufacturing, and not strong enough to allow direct transmission of the torque from the permanent magnet 37 to the rotary shaft 14 during high-speed rotation.

For the permanent magnet 37, a neodymium magnet (Nd—Fe—B), a samarium cobalt magnet, or the like may be used, for example. For a material of the armoring ring 43, a non-magnetic metal such as alloy 718 or Ti64 (Ti-6Al-4V) may be used. For a material of the end rings 39, a non-magnetic metal such as SUS, a thermosetting resin, or a thermoplastic resin may be used.

In order to reliably perform the torque transmission between the permanent magnet 37 and the armoring ring 43 when the motor rotor 25 rotates at high speed, the permanent magnet 37 and the armoring ring 43 may need to be firmly joined together. Thus, the permanent magnet 37 and the armoring ring 43 are integrally sintered to be firmly joined together. A method for manufacturing the motor rotor 25 having such a permanent magnet 37 and armoring ring 43 includes a sintering process in which a molded body is sintered. The molded body is a multi-layered molded body in which, around a metal powder molded body, another metal powder molded body is superposed. The metal powder molded body (e.g., magnet molded body) is formed from a metal powder of a material (e.g., magnetic metal) of the permanent magnet 37, and the other metal powder molded body (e.g., armoring ring molded body) is formed from a metal powder of a material (e.g., non-magnetic metal) of the armoring ring 43. An example method for manufacturing the motor rotor 25 illustrated in FIG. 2 is as follows.

First, the metal powder, which is the material of the permanent magnet 37, is mixed with a predetermined binder, and is packed into a mold and compressed to form a cylindrical metal powder molded body 51, as shown in FIG. 3A. Further, a mixture of the metal powder, which is the material of the armoring ring 43, and a predetermined binder is placed around the metal powder molded body 51, and is packed into a mold together with the metal powder molded body 51 and compressed. Thus, the mixture is formed into a metal powder molded body 52, as shown in FIG. 3B. The metal powder molded body 52 is formed into a cylindrical shape that surrounds an outer circumferential surface of the metal powder molded body 51, and comes into close contact with the outer circumferential surface of the metal powder molded body 51.

Next, a composite molded body 53, which is formed by superposing the metal powder molded body 51 on the metal powder molded body 52 in the radial direction Dr as described above, is sintered. The composite molded body 53 may be heated and pressurized while packed into a mold. Thus, as shown in FIG. 3C, the cylindrical permanent magnet 37 corresponding to the metal powder molded body 51 portion and the cylindrical armoring ring 43 corresponding to the metal powder molded body 52 portion are sintered together and integrated with each other. After that, the integrated permanent magnet 37 and armoring ring 43 are attached to the rotary shaft 14 together with the end rings 39, completing the motor rotor 25 (FIG. 2) attached to the rotary shaft 14.

Also, typical sintering temperatures for sintering each metal material are 1040° C. for neodymium magnets, 1215° C. for samarium cobalt magnets, 1450° C. for Ti64, and 1250° C. for Alloy 718. Since the composite molded body 53 contains two of these metal materials, the sintering temperature for sintering the composite molded body 53 is set to the lower of general sintering temperatures for the two metal materials, and sintering is performed for a longer time than general sintering times.

For example, if the permanent magnet 37 of the motor rotor 25 is a neodymium magnet and the armoring ring 43 is Ti64, the sintering temperature of the motor rotor 25 is lower that the sintering temperature of the armoring ring 43. In the mode, the sintering temperature for the composite molded body 53 is set to 1040° C., which is a general sintering temperature of neodymium magnets on a lower temperature side. For example, if the permanent magnet 37 of the motor rotor 25 is a neodymium magnet and the armoring ring 43 is Alloy 718, the sintering temperature for the composite molded body 53 is set to 1040° C., which is the general sintering temperature of neodymium magnets on the lower temperature side. For example, if the permanent magnet 37 of the motor rotor 25 is a samarium-cobalt magnet and the armoring ring 43 is Ti64, the sintering temperature of the composite molded body 53 is set to 1215° C., which is a general sintering temperature of samarium-cobalt magnets on a lower temperature side. For example, if the permanent magnet 37 of the motor rotor 25 is a samarium-cobalt magnet and the armoring ring 43 is Alloy 718, the sintering temperature of the composite molded body 53 is set to 1215° C., which is the general sintering temperature of samarium-cobalt magnets on the lower temperature side.

In the method for manufacturing the motor rotor 25, as described with reference to FIGS. 3A, 3B, and 3C, the permanent magnet 37 and the armoring ring 43 are integrally sintered from the state in which the metal powder molded bodies 51 and 52 are in close contact with each other as described above. Accordingly, diffusion occurs between the metals at an interface between the metal of the material of the permanent magnet 37 and the metal of the material of the armoring ring 43, and the permanent magnet 37 and the armoring ring 43 are firmly joined due to diffusion bonding between the metals. According to such a joining method, it may not be necessary to adjust surface roughness of joining surfaces of the two components or to strictly control tolerances of the two components. As a result, the productivity of the motor rotor 25 may be improved. Further, the productivity of the electric motor 21 and the turbocharger 1 to which the motor rotor 25 is applied is also improved.

It is to be understood that not all aspects, advantages and features described herein may necessarily be achieved by, or included in, any one particular example. Indeed, having described and illustrated various examples herein, it should be apparent that other examples may be modified in arrangement and detail.

Some additional examples are disclosed as follows, with continued reference to the drawings for convenience of description.

An example motor rotor (25) including: a cylindrical magnet located around a rotary shaft (14) and a cylindrical armoring ring (43) located around the magnet (37). The magnet (37) and the armoring ring (43) are integrally sintered.

In some examples, the motor rotor (25) may include an end ring (39) contacting the magnet (37) in an axial direction (Da) of the rotary shaft (14).

In some examples, the magnet (37) may be bonded to the rotary shaft (14), and the end ring (39) may be press fitted to the rotary shaft (14).

In some examples, a joint strength between the magnet (37) and the rotary shaft (14) may be lower than a joint strength between the end ring (39) and the rotary shaft (14).

In some examples, the end ring (39) may include one or both of a non-magnetic metal and a resin.

In some examples, the end ring (39) may contact an inner circumferential surface (Sa) of the armoring ring (43) in a radial direction (Dr) of the rotary shaft (14).

In some examples, the armoring ring (43) may include a cylindrical end portion (43a) that protrudes from the magnet (37) in an axial direction (Da) of the rotary shaft (14).

In some examples, the motor rotor (25) may include an end ring (39) contacting an inner circumferential surface (Sa) of the cylindrical end portion.

In some examples, the motor rotor (25) may include a first end ring (39) contacting the magnet (37) in an axial direction (Da) of the rotary shaft (14) and a second end ring (39) contacting the magnet (37) in the axial direction (Da). The magnet (37) may be located between the first end ring (39) and the second end ring (39).

In some examples, the first end ring (39) and the second end ring (39) are press-fitted onto an inner circumferential surface (Sa) of the armoring ring (43).

In some examples, the magnet (37) may include a magnet molded body (51) formed from a metal powder, the armoring ring (43) may include an armoring ring molded body (52) formed from a non-magnetic metal powder, and the magnet molded body (51) and the armoring ring molded body (52) are integrally sintered.

In some examples, the armoring ring (43) may be made from a non-magnetic metal, and the magnet (37) may be made from a magnetic element having a lower sintering temperature than a sintering temperature of the non-magnetic metal.

In some examples, the magnetic element comprises a neodymium magnet or a samarium-cobalt magnet.

In some examples, the non-magnetic metal comprises one or both of alloy 718 and Ti64.

Additionally, an example electric motor (21) is disclosed herein. The electric motor (21) includes some examples of the motor rotor (25).

Additionally, an example turbocharger (1) is disclosed herein. The turbocharger (1) includes some examples of the electric motor (21) as an assisting electric motor that applies a torque to the rotary shaft (14) of an impeller.

An example method for manufacturing a motor rotor, which includes a cylindrical magnet (37) located around a rotary shaft (14) and a cylindrical armoring ring (43) located around the magnet (37), includes forming a composite molded body by superposing a first molded body for the armoring ring (43) around a second molded body for the magnet (37) and forming integrally sintered the magnet and the armoring ring by sintering a composite molded body.

In some examples, the armoring ring molded body (52) is formed from a non-magnetic metal powder and the magnet molded body (51) is formed from a magnetic metal powder.

In some examples, the method for manufacturing the motor rotor includes press-fitting an end ring (39) onto an inner circumferential surface (Sa) of the armoring ring (43).

In some examples, the magnet molded body (51) has a sintering temperature which is lower than a sintering temperature of the armoring ring molded body (52).

What is claimed is:

1. A motor rotor comprising:
a cylindrical magnet located around a rotary shaft; and
a cylindrical armoring ring located around the magnet,
wherein the magnet and the armoring ring are integrally sintered.

2. The motor rotor according to claim 1, further comprising an end ring contacting the magnet in an axial direction of the rotary shaft.

3. The motor rotor according to claim 2,
wherein the magnet is bonded to the rotary shaft, and
wherein the end ring is press fitted to the rotary shaft.

4. The motor rotor according to claim 3, wherein a joint strength between the magnet and the rotary shaft is lower than a joint strength between the end ring and the rotary shaft.

5. The motor rotor according to claim 2, wherein the end ring comprises one or both of a non-magnetic metal and a resin.

6. The motor rotor according to claim 2, wherein the end ring contacts an inner circumferential surface of the armoring ring in a radial direction of the rotary shaft.

7. The motor rotor according to claim 1, wherein the armoring ring includes a cylindrical end portion that protrudes from the magnet in an axial direction of the rotary shaft.

8. The motor rotor according to claim 7, further comprising an end ring contacting an inner circumferential surface of the cylindrical end portion.

9. The motor rotor according to claim 1, further comprising:
a first end ring contacting the magnet in an axial direction of the rotary shaft; and
a second end ring contacting the magnet in the axial direction,
wherein the magnet is located between the first end ring and the second end ring.

10. The motor rotor according to claim 9, wherein the first end ring and the second end ring are press-fitted onto an inner circumferential surface of the armoring ring.

11. The motor rotor according to claim 1,
wherein the magnet includes a magnet molded body formed from a metal powder,
wherein the armoring ring includes an armoring ring molded body formed from a non-magnetic metal powder, and
wherein the magnet molded body and the armoring ring molded body are integrally sintered.

12. The motor rotor according to claim 1,
wherein the armoring ring is made from a non-magnetic metal, and
wherein the magnet is made from a magnetic element having a lower sintering temperature than a sintering temperature of the non-magnetic metal.

13. The motor rotor according to claim 12, wherein the magnetic element comprises a neodymium magnet or a samarium-cobalt magnet.

14. The motor rotor according to claim 12, wherein the non-magnetic metal comprises one or both of alloy 718 and Ti64.

15. An electric motor including the motor rotor according to claim 1.

16. A turbocharger including the electric motor according to claim 15 as an assisting electric motor that applies a torque to the rotary shaft of an impeller.

17. A method for manufacturing a motor rotor including a cylindrical magnet located around a rotary shaft and a cylindrical armoring ring located around the magnet, the method comprising:
forming a composite molded body by superposing an armoring ring molded body around a magnet molded body; and
forming an integrally sintered body of the magnet and the armoring ring by sintering the composite molded body.

18. The method for manufacturing the motor rotor according to claim 17,
wherein the armoring ring molded body is formed from a non-magnetic metal powder, and
wherein the magnet molded body is formed from a magnetic metal powder.

19. The method for manufacturing the motor rotor according to claim 17, further comprising press-fitting an end ring onto an inner circumferential surface of the armoring ring.

20. The method for manufacturing the motor rotor according to claim 17, wherein the magnet molded body has a sintering temperature which is lower than a sintering temperature of the armoring ring molded body.
